(19) United States
(12) Patent Application Publication
(10) Pub. No.: US 2015/0046299 A1
(43) Pub. Date: Feb. 12, 2015

(54) Inventory Assessment with Mobile Devices

(71) Applicant: Sui Yan, Mountain View, CA (US)

(72) Inventor: Sui Yan, Mountain View, CA (US)

(73) Assignee: SAP AG, Walldorf (DE)

(21) Appl. No.: 13/964,409

(22) Filed: Aug. 12, 2013

(51) Int. Cl. G06Q 10/08

(52) U.S. Cl. CPC G06Q 10/087
USPC 705/28

(57) ABSTRACT

In one embodiment, an inventory level assessment feature or service is provided for a camera-enabled mobile device such that a user of such mobile device can use the mobile device to measure inventory levels of a product in a physical location (e.g., a warehouse, a retail store or another context) pictured in one or more captured images from such device. Among other things, as the user points the mobile device's camera at one or more sections of the physical location, data relating to the captured image or images of such sections of the physical location are transmitted to and processed by a remote inventory assessment engine to determine a current inventory level of the product in the imaged section or sections.

### BACKGROUND OF THE INVENTION

The invention disclosed herein relates generally to computing and data processing. More specifically, the invention relates to the use of camera enabled mobile devices to provide information regarding objects in captured images.

Unless otherwise indicated herein, the approaches described in this section are not prior art to the claims in this application and are not admitted to be prior art by inclusion in this section.

Tracking inventory levels, whether in a storage facility, retail store or another context, can be an important requirement for businesses. Inventory assessments can serve various purposes, including, for example, determining an amount of product currently in stock, or confirming whether product placement in a retail store complies with product presentation designs. Field representatives frequently visit retail stores or warehouses to assess current inventory levels to ensure that there is sufficient inventory in stock. They may perform calculations based on recent sales forecasts to determine whether more inventory should be ordered—a process that is time intensive and susceptible to error. Or, in the alternative, they may perform eye ball assessments to estimate inventory levels—a process that is imprecise.

Mobile devices have become widely used and easily accessible. Among other things, mobile devices usually include a camera for capturing images, and a display for displaying images seen in the camera's viewfinder. Further, mobile devices, such as smart phones or personal digital assistants (PDAs), are generally capable of connecting to wide area networks, such as the Internet.

The ability of mobile devices to capture images and transmit them to remote computing environments provides an opportunity to improve techniques for assessing inventory levels. It would be advantageous to provide systems and methods for utilizing the networking and image capture capabilities of mobile devices to facilitate assessments of inventory.

### BRIEF SUMMARY OF THE INVENTION

Various embodiments of the present disclosure provide assessment of inventory levels using images captured by a camera-enabled mobile device. Examples of such mobile devices include personal digital assistants (PDAs), smartphones, tablet computers, and high technology eye wear such as Google Glasses recently introduced by Google Inc.

In one embodiment, an inventory assessment feature is provided for a camera-enabled mobile device so that a user of the mobile device can use the mobile device to measure inventory levels of a product in a physical location (e.g., a warehouse or a retail store) pictured in one or more images captured by such device. As the user points the mobile device's camera at one or more sections of the physical location, data relating to the captured image or video of such sections of the physical location are transmitted to and processed by a remote inventory assessment engine to determine a current inventory level for the imaged section(s), and the remote inventory assessment engine then provides meta data relating to the determined current inventory level to the mobile device.

In some embodiments, the meta data includes interactive portions allowing the user to select among different options for proceeding, the options including an option to place a purchase order for the product.

In some embodiments, a representation of a captured image sent by the mobile device is overlaid with the meta data, and the overlaid representation is returned to the mobile device to display to a user. Such representations of the meta data may provide an augmented reality view of the captured image.

In some embodiments, the inventory assessment engine estimates when inventory is likely to be depleted based at least in part on sales forecasts for the product and the current inventory level, and provides meta data relating to the estimated depletion date to the user.

In some embodiments, the meta data comprises information relating to a number of units of the product needed to fully replenish stock of the product.

A physical location where inventory levels are to be measured may be divided into sections or cells to facilitate inventory assessment. In some embodiments, these sections may be demarcated by boundary markers, for example, dots or lines placed on shelves to indicate boundaries of sections. Further, in some embodiments, the sections may be identified by labels (e.g., indicating an aisle and shelf number), such labels affixed to the shelves in manner such that the labels are visible to a viewer of the physical location.

In some embodiments, as the user points the mobile device's camera at one or more sections of the physical location and captures an image or images of the one or more sections, location information identifying the section (s) captured in the image or images is also transmitted to and processed by the remote inventory assessment engine. In some embodiments, said section(s) of the physical location depicted by the captured image or images may be identified by section identifier(s) received from a user via a user interface of the mobile device.

In alternative embodiments, a section captured in an image may be identified by performing image analysis on the captured image and identifying section label(s) located in the portion of the physical location captured in the image.

In some embodiments, the location information transmitted to the inventory assessment engine identifying the sections of the physical location captured in the captured image or images may comprise a combination of GPS location information, compass directional orientation information, and camera angle of view information, for the mobile device. Such mobile-device location information may then be used by the inventory assessment engine to select a portion of the data in an image information database to access for comparison with the captured image.

Such mobile-device location information may be used to identify the portion of the physical location depicted in the image or images captured by the mobile device using the following process, for example:

determining, based at least in part on the GPS location information and stored map information showing where shelves are located, a distance between an imaged shelf and a camera of the mobile device;

determining, based at least in part on the distance and the compass directional orientation information, a point (x, y) that maps to a central point of a field of view of the camera of the mobile device;

determining, based at least in part on the distance d, the GPS location information and the camera angle of view information, dimensions of an image area (W′, H′) that is capturable by the camera, wherein the dimensions (W′, H′) reflect dimensions of the captured image; and determining, based at least in part on the point (x, y) and the dimensions (W′, H′), the dimensions and location of the portion of the physical location captured by the image.

In some embodiments, processing the captured image or images of the physical location to determine the current inventory level comprises:

retrieving a unit image of a single unit of such product, and

counting, using image analysis and object recognition processes, a number of instances of the unit image contained in the captured image or images.

According to some embodiments, a captured image or images of one or more sections of a physical location are processed to determine a difference between a current inventory level and a full level of inventory in the one or more sections of the physical location. Such processing may comprises retrieving, from an image information database, data regarding target inventory-levels for the section(s) of the physical location shown in the captured image(s).

Data relating to target inventory-levels may take a variety of forms. According to some embodiments, where the physical location has been divided into cells or sections to facilitate inventory assessment, the data may take the form of an array, each element of the array comprising a number reflecting the target amount of inventory to be stocked in the corresponding section.

In the alternative, in other embodiments, the data relating to target inventory levels may take the form of planogram files, which represent the key design characteristics of all or part of the physical location, including details relating to desired placement of inventory and desired quantity of inventory at different locations. In some embodiments, such planograms may be defined in a format that uses a structured-language, such as Extensible Markup Language (XML).

According to other embodiments, the data may take the form of image files, such as .png files, which comprise images of the physical location as it appears when fully stocked with inventory.

In some embodiments, once the sections of the physical location captured in a captured image are identified based on the mobile-device location information, corresponding data stored in an image information database (e.g., which may take the form of an array, planograms, or image files), may be accessed and data regarding such corresponding portions provided to the inventory assessment engine for comparison with data relating to the captured image.

In some embodiments, comparison of the captured image data, and the target inventory-level data retrieved from the image information database, may comprise:
a) retrieving an image of a single unit of such product, and determining, using image analysis and/or object recognition processes, a number of instances of the unit image contained in the captured image;
b) identifying a target inventory-level for the section or sections of the physical location associated with the captured image; and
c) comparing the number of instances of the unit image contained in the captured image with the identified target inventory-level.

In other embodiments, comparison of the captured image data, and the target inventory-level data retrieved from the image information database, may comprise extracting information from the image data to create a first planogram, retrieving, from an image information database, a stored planogram or section of a stored planogram reflecting a desired level of inventory in the section or sections captured in the image, and comparing the first planogram and the stored planogram or section of the stored planogram.

In another embodiment, the invention pertains to a mobile device having a camera for capturing images, and a display for displaying the captured images. The mobile device further includes a processor and a memory that are configured to perform one or more of the above described operations. In another embodiment, the invention pertains to a system having a processor and memory that are configured to perform one or more of the above described operations. In another embodiment, the invention pertains to at least one computer readable storage medium having computer program instructions stored thereon that are arranged to perform one or more of the above described operations.

The following detailed description and accompanying drawings provide a better understanding of the nature and advantages of the present invention.

### BRIEF DESCRIPTION OF THE DRAWINGS

The invention is illustrated in the figures of the accompanying drawings which are meant to be exemplary and not limiting, in which like references refer to like or corresponding parts, and in which:

FIG. 1 illustrates a block diagram presenting a network topology in which captured images obtained by a mobile device are transmitted to and processed by a remote inventory assessment engine to assess inventory levels at a physical location according to one embodiment of the present invention;

FIG. 2 is a flow diagram presenting a method of assessing inventory levels using images captured by a mobile device according to one embodiment of the present invention;

FIG. 3 is a is a flow diagram illustrating the operation of FIG. 2 for processing location information and searching a database to identify target inventory-level information for sections of the physical location pictured in the captured images according to one embodiment of the present invention;

FIG. 4 is a diagrammatic representation of various variables relevant to a calculation of the dimensions and location of a section of a physical location photographed by a mobile device according to one embodiment of the present invention. It shows a user capturing an image of a section of a storage shelf using a mobile device, as well as indicating the features in such a configuration which correspond to variables in such calculations;

FIG. 5 is a flow diagram illustrating the operation of FIG. 2 for performing comparisons according to one embodiment of the present invention;

FIG. 6A shows a mobile device in the form of an iPhone upon which instructions to take a picture are displayed according to one embodiment of the present invention;

FIG. 6B illustrates an outline of a rectangular shape being overlaid over to camera's viewfinder image in the display of the mobile device of FIG. 6A according to one embodiment of the present invention;

FIG. 6C illustrates the mobile device of FIG. 6A upon which instructions to provide section identifying information regarding a captured section of the storage space is displayed according to one embodiment of the present invention;

FIG. 6D illustrates the mobile device of FIG. 6A upon which instructions to take a picture of a single unit of the inventoried product is displayed according to one embodiment of the present invention;

FIG. 6E illustrates the mobile device of FIG. 6A upon which instructions for the user to indicate if he/she would like to assess inventory in additional sections of the storage space is displayed according to one embodiment of the present invention;

FIG. 6F upon which instructions for the user to indicate if he/she would like to place a purchase order to replenish inventory is displayed according to one embodiment of the present invention; and

FIG. 7 illustrates hardware of a special purpose computing machine configured to perform a process according to various embodiments of the present invention.

### DETAILED DESCRIPTION

Described herein are techniques for assessing inventory levels using mobile devices. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

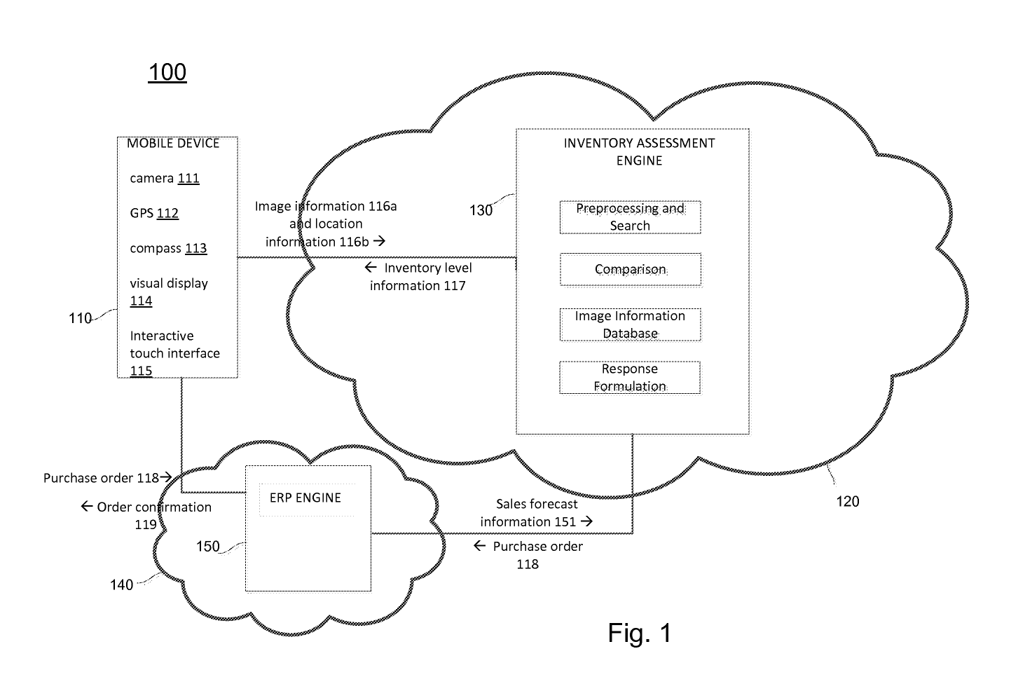

Embodiments of a method and system for assessing inventory using mobile devices having image capture capabilities, in accordance with the present invention, are described herein with reference to the drawings in FIGS. 1 through 7.

Features of the present disclosure include using images of a physical space generated by a camera-enabled mobile device to generate inventory level assessments. In one example embodiment, a field representative uses a mobile device such as an iPhone or Google glasses to take pictures of a stock shelf. The images are then transmitted to a remote server which calculates an amount of product shown in the captured images and returns that information to the field representative. In some embodiments, a purchase order to obtain additional inventory is prepared by the remote server and transmitted to an Enterprise Resource Planning (ERP) engine.

Advantages of the present disclosure include allowing a field representative to assess and replenish inventory easily and quickly. Performing inventory assessment using a mobile device connected to remote servers allows for cost savings and greater efficiency, replacing time intensive human calculations with an automated system that can quickly generate inventory numbers with less human involvement. As described above, various embodiments of the present disclosure provide a system or method for determining an amount of inventory in a storage space It will be understood, however, that the invention is not restricted to assessing inventory but may be utilized in any context where determining a change in the count of a particular object in a specific physical location is useful.

Embodiments for an inventory assessment system using mobile devices may be implemented in a wide variety of networking contexts. Turning to FIG. 1, a network topology comprising hardware and software components configured according to one embodiment of the present invention is illustrated. The network topology presented comprises a mobile device 110, connected to a first network 120 that includes an inventory assessment engine 130. The inventory assessment engine 130 may comprises one or more servers, and may include any suitable modules for determining inventory levels based on image capture data as discussed further herein. Inventory assessment engine 130 shown in FIG. 1 includes an information preprocessing and search module 131, a comparison module 132, an image information database 133, and a response formulating module 134, which operate together to return inventory level information to mobile device 110 for displaying to a user. Inventory assessment engine 130 may be accessed by mobile device 110 through a wireless connection to the Internet, for example. Embodiments of the above network topology may be implemented in a wide variety of network environments including, for example, Ethernet networks, TCP/IP-based networks, telecommunications networks, and wireless networks, etc., or a combination of such networks

Mobile device 110 and inventory assessment engine 130 are both connected to a second network 140, which includes an Enterprise Resource Planning (ERP) engine 150. Second network 140 may be a private network associated with a particular company, for example, or it may be a public network. ERP engine 150 performs enterprise resource planning functions including receiving and processing sales orders, calculating an amount of inventory that should be ordered based in part on an estimate of existing inventory, estimating a date by which existing inventory will be depleted if not replenished.

As noted above, inventory assessment engine 130 includes an image preprocessing and search module 131, an image information database 132, a comparison module 133, and a response formulating module 134, which operate together to return inventory level information to mobile device 110 for display to a user.

According to one embodiment, when inventory assessment engine 130 receives inventory image and location information 116 from mobile device 110, it's preprocessing and search module 131 processes that information to select an appropriate data file or information to obtain from image information database 132. As discussed further below, the selection of appropriate data from image information database 132 can be performed in a variety of ways, as further described herein.

After the appropriate data has been obtained from image information database 132, comparison module 133 uses that information to compare the image captured by mobile device 100 with information obtained from image information database 133 regarding the amount of inventory the pictured area would contain when fully stocked. Such comparison produces a number relating to the currently inventory level for the scene captured in the image(s) sent by mobile device 110.

The response formulating module 134 then uses the inventory level number or related information obtained in the comparison process to formulate a message to return to the user regarding the level of current inventory. The response message can be in the form of text to be shown on a user interface of mobile device 110. In the alternative, the response message can be in the form of an image of the space in question overlaid with text showing inventory level information 117. Various other forms of response messages will be apparent to one of skill in the art. Response formulating module 134 then transmits inventory level related information 117, whatever form it takes, back to mobile device 110. Examples of information that inventory level related information 117 can include are: a number of inventory items currently in stock, when inventory is likely to be depleted, how many units of inventory need to be ordered to fully replenish stock, etc.

Implementations are contemplated in which users can interact with inventory assessment engine 130 using a diverse range of mobile devices 110, e.g., a personal digital assistant (PDA), smartphone, high technology eyewear, such as the recently introduced Google glasses from Google Inc., a tablet computer, a laptop, etc. As shown in FIG. 1, mobile device 110 is operable to capture and send an image, and possibly location/direction/and camera field-of-view information to inventory assessment engine 130. As shown, mobile device 110 may have a cameras component 111 for capturing images, a GPS component 112 with sensors for identifying location of mobile device 110, a compass component 113 with sensors for identifying directional orientation of mobile device 110 (for example, compass component 113 may identify which direction camera 111 of mobile device 110 is pointing to). Mobile device 110 also contains interfaces for communicating with other devices through networked connections. It may also have visual and/or audio interfaces for providing and receiving information from a user. As illustrated in FIG. 1, mobile device 110 has a visual display 114. The visual display may convey information in the form of text, images, links, etc. Mobile device 110 also has an interactive touch interface 115 for receiving user input.

In some embodiments, in conjunction with performing inventory assessment functionality, mobile device 110 further implements application software for assessing inventory levels as provided by embodiments of the present disclosure. The use of the application software allows mobile device 110 to perform inventory assessment when used in conjunction with inventory level assessment engine 130. Embodiments of the application software may be integrated as a component of one or more server applications or it may be a stand-alone program executing on inventory assessment engine 130.

In various embodiments, application software may also convert mobile device 110 into an augmented reality enabled device. In such embodiments, mobile device 110 displays images of its surroundings overlaid with information obtained from inventory assessment engine 130 and ERP engine 150 relating to objects captured by the viewfinder of its camera 111. For example, mobile device 110's display may show an image of a particular warehouse shelf captured by mobile device 110's camera, overlaid with inventory related information 117 returned by inventory assessment engine 130 after processing image data 116 relating to the image in accordance with various embodiments. Presenting such information to the user, overlaid on an image captured by camera 111 of mobile device 110, provides the user with an enhanced or “augmented” view of reality, specifically, in the present example, a view of the user's surroundings augmented with data provided by inventory assessment engine 130.

In other embodiments, inventory related information 117 returned by inventory assessment engine 130 to mobile device 110 may be communicated to a user using a natural language voice interface of mobile device 110.

According to one embodiment, inventory assessment engine 130 may comprise a single server. In alternative embodiments, inventory assessment engine 130 may correspond to multiple distributed servers and data stores, which, for example, may be part of a cloud network, and which together perform the functions described herein. Such a system of distributed servers and data stores may execute software programs that are provided as software services (e.g., Software-as-a-Service (SAAS)). Embodiments of a distributed inventory assessment engine 130 may be implemented in a wide variety of network environments as further described herein.

According to one embodiment, inventory assessment engine 130 may calculate items such as when inventory is likely to be depleted and other inventory related information, based in part on sales forecasts and other business information 151 received from ERP engine 150. As noted above, ERP engine 150 is located in second network 140, which for example may be a private network operated by a particular enterprise.

According to one embodiment, after receiving inventory level related information 117 from inventory assessment engine 130, mobile device 110 may send a sales order 118 to ERP engine 150 in network 140. ERP engine 150 may respond with a confirmation message 119. ERP engine 150 may be accessed by mobile device 110 through a wireless connection to the Internet, for example.

In one example, a field representative scans a storage shelf with a mobile device. This scan may be performed using any camera enabled mobile device, such as Apple iPad, iPhone, Google Glasses, etc. Information regarding the captured image, including image related data as well location information identifying the location of the captured image are sent to inventory assessment engine 130. The location information is described in further detail below. Inventory assessment engine 130 calculates the amount of inventory missing from the space, and transmits current inventory level information 117 to mobile device 110. Mobile device 110 then informs the field representative via a natural language (voice) user interface of this information. For example, the camera-enabled mobile device says through its audio interface “The inventory level is very low. It will run out in 4 days according to my latest sales forecast. You need to order 850 units to fully replenish this storage. Do you want to proceed?” In response, the field sales representative may say into a microphone of mobile device 110: “Yes please send the order for 850 unites.” In response, inventory assessment system 130 may automatically process an order by sending a message to ERP engine 150.

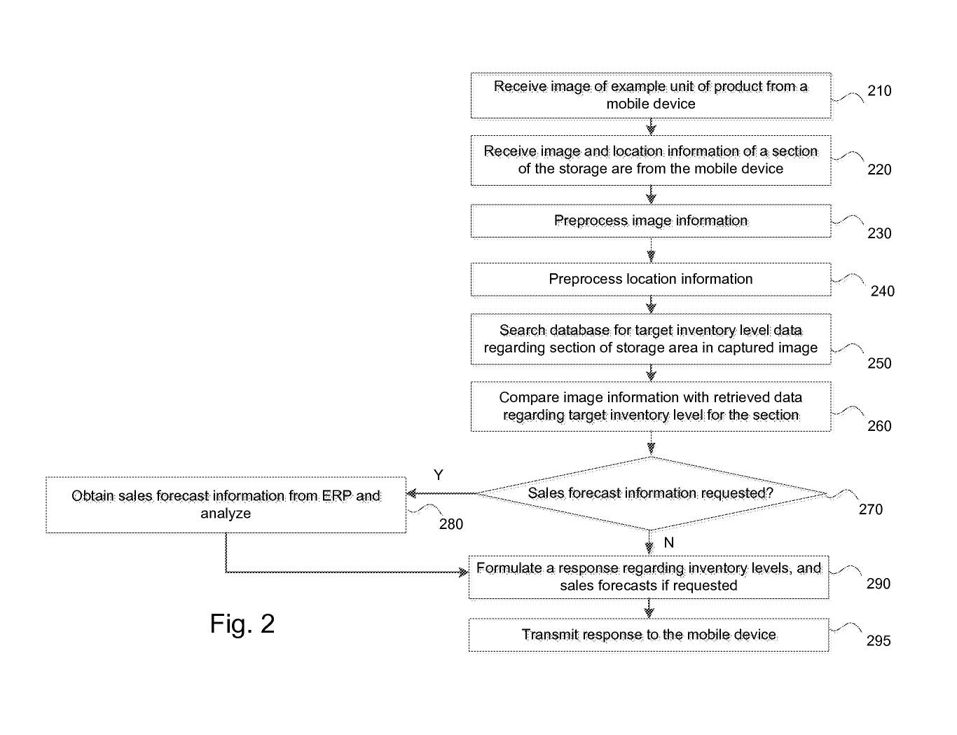

FIG. 2 is a flow diagram illustrating a method performed by an inventory assessment engine according to one embodiment. The specific example of an inventory assessment engine depicted in FIG. 1 will be referenced for purposes of explanation, but it will be understood that, in practice, inventory assessment engines performing the below process need not have all of the features, or the same network context, as inventory assessment engine 130.

In one example, to initiate an inventory assessment feature, a user registers with an inventory assessment service. Once registration is completed, the user may access the inventory assessment feature on their mobile device. When this occurs, an indication that the inventory assessment service has been selected by the user of mobile device 110 may be received by the inventory assessment service. FIG. 2 illustrates some of the steps that might follow.

In 210, image information regarding an example unit image of an inventory item as it would appear in, for example, a front view of a warehouse shelf, is received. In alternative embodiments, such example inventory unit image may be stored in image information database 133 and retrieved by comparison module 132 in comparison step 260 described further below.

In 220, image information 116a and location information 116b are received from mobile device 110, such information relating to a portion of a storage space captured by the user using camera 111 of mobile device 110.

Image information 116a may in some embodiments include a copy of the captured digital image. Location information 116b may take different forms. It may include section identifying information identifying the section of the storage facility captured in the associated image or images. In addition, or in the alternative, it may include information relating to the location and orientation of mobile device 110, which then may be used in conjunction with layout information regarding the placement of shelving units, for example, to determine the dimensions and location of the portion of the physical location captured in the image.

In 230, preprocessing is performed on the received captured image, using object recognition analysis to count a number of instances of a stored product appearing in the captured image. For example, the example unit image received in step 210 may be used to count the number of inventory items contained in the captured image received in step 220. This counting process might involve various image processing tools, including but not limited to object recognition software.

In 240, a preprocessing of the location information is performed using location information 116b to select the appropriate information from image information database 133, such information corresponding to the same portion of the physical location pictured in the captured images 116a.

In 250, a search query is prepared and sent to image information database 133 for such information.

Information may be stored in image information database 133 in a variety of different forms. According to one embodiment, images of the entire warehouse may be stored in an image information database 133 of inventory assessment engine 130. In some embodiments, such information may be stored in the form of Portable Network Graphics (.png) files or some other form of visual graphic file. In other embodiments, such images may be preprocessed, for example, by converting such images to Extensible Markup Language (XML), and such XML files (e.g., embodying planograms) may be stored in image information database 133.

Alternatively, in other embodiments, where the warehouse has been divided into different cells or sections, an array of numbers corresponding to a count of inventory in each section when inventory may be maintained in database 133.

One challenge faced in performing inventory assessment using captured images is correctly matching a section of a warehouse photographed (or otherwise captured) by a mobile device with the corresponding data in an image information database. Such matching must be fairly exact as comparing data regarding different warehouse sections will not produce useful results. It is contemplated that a variety of mechanisms could be used to store data in, and select appropriate data from, image information database 133, in connection with performing such comparisons.

Where the location information provided by mobile device 110 provides a cell or section identification (e.g., by using a shelf ID), the query to database 133 may simply take the form of requesting information for that cell or section, for example. Where the location information provided by mobile device 110 instead constitutes GPS, compass and camera field of view information, a further analysis of location information 116b to determine an appropriate database request or query to make to image information database 133 may be necessary. For example, calculations may need to be performed to determine the dimensions and location of the space captured in the image(s), and such captured space information may then be used as the basis of a query sent to image information database 133. It will be understood that use of location information of the two above described forms (i.e., section-identification and mobile-device location-and-orientation identification) are not exclusive, and may be used in combination, and/or in conjunction with other techniques.

In 260, a comparison process is performed comparing the image or other information obtained from image information database 133, to the image data provided by mobile device 110, to determine a number of inventory items missing from the captured storage space, as further discussed below.

In 270, it is determined whether the user has requested that sales forecast and/or other business information be provided along with inventory count information.

In 280, if sales forecast or other business related information has been requested, sales forecast information regarding the inventoried product is obtained from ERP engine 150, and analyzed. For example, it may be determined how soon the inventory is likely to run out, and/or how many units need to be ordered to full replenish inventory stock.

In 290, a suitable response is formulated to the user regarding inventory levels, and possibly also sales order, sales forecast, and/or other related information, if such information has been requested. In 295, such information is transmitted to the mobile device. It is noted that the mobile device may communicate the information to the user in a variety of different ways. For example, where the mobile device takes the form of a smartphone, either a visual display or a natural language audio interface may be used to communicate the inventory-level related information to the user.

In another embodiment, if the mobile device takes the form of or includes high technology eye wear, such as glasses or goggles, such information may be projected on a screen within the user's field of vision. Such high technology eye wear typically includes a small camera that can record images that are seen by the user. The goggles or glasses may be configured to send the captured images to a mobile communications device via a wireless communication signal or the goggles may themselves be configured as a wireless communications device with a network interface that can be used to connect to wide area networks, such as the Internet. The image may then be sent to an inventory assessment engine as described above in order to obtain current inventory level related meta data. The obtained meta data can then be projected onto a small screen of the goggles or glasses that is in the field of view of the user. In some embodiments, the meta data may be overlaid over the viewed scene.

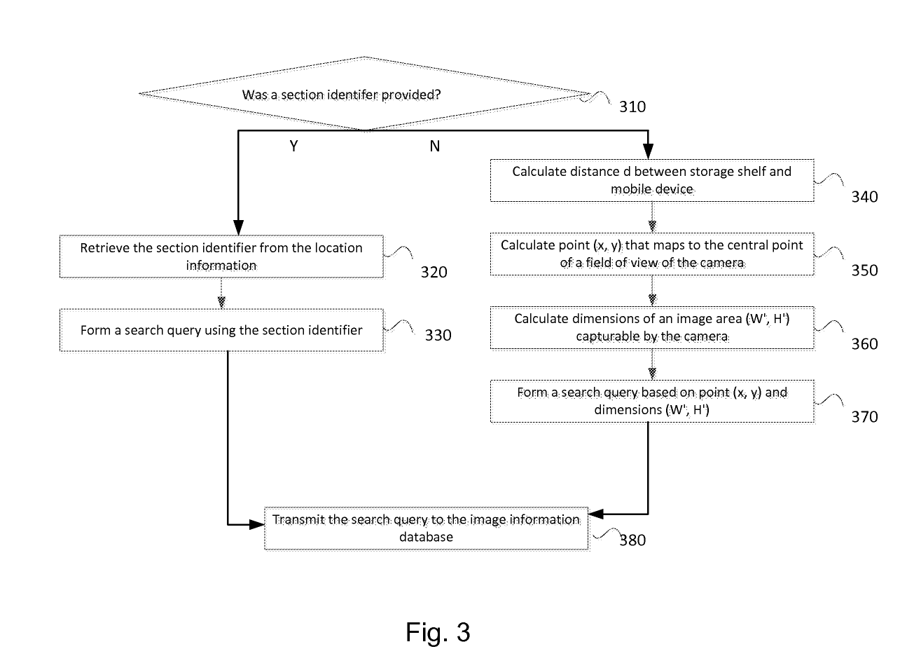

FIG. 3 is a flow diagram which illustrates in more detail the preprocessing and search steps 230, 240, 250 of FIG. 2

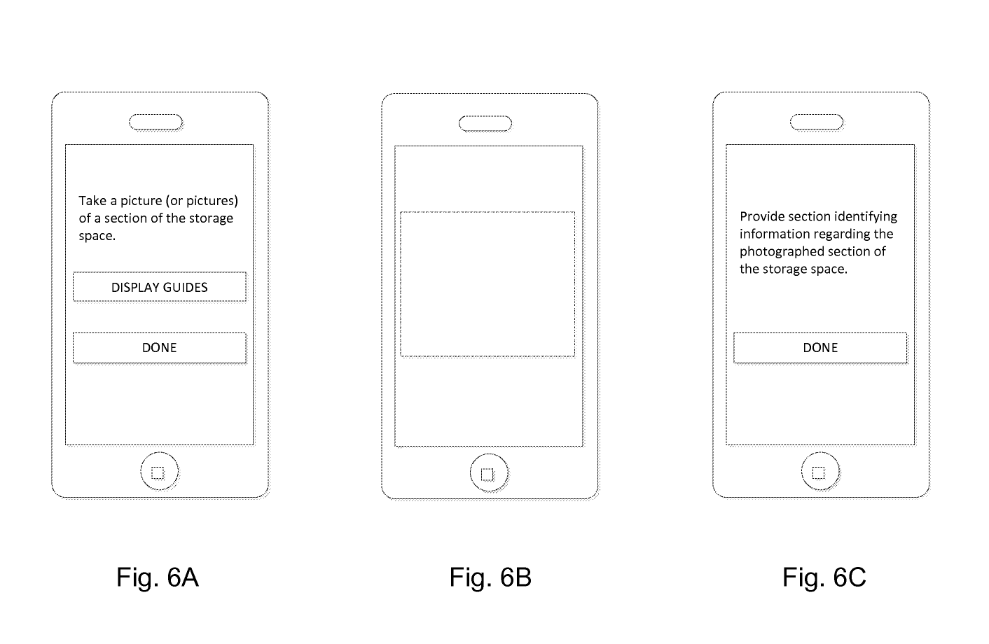

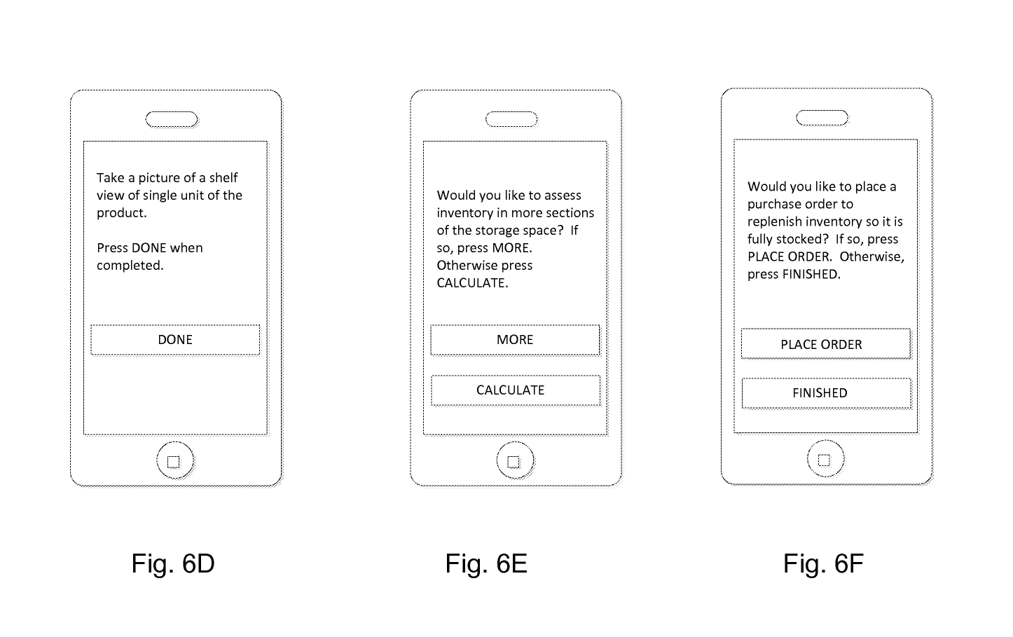

According to one embodiment, referencing indicators such as glowing dots might be installed on the shelves of a storage space, to divide the storage location into different sections or cells. Each such section of the storage location may be delineated by dots, lines or other boundary markers placed on the shelving, for example. These markers may then be used as guides by a user in taking pictures of the storage space. Further, when a user takes a picture of a particular section, mobile device 110's user interface may assist the user to shoot within the range of four such boundary dots, or centered around one dot, for example, as further described below, and as illustrated in FIG. 6B.

The left branch of the flow diagram shown in FIG. 3 illustrates the process that m might apply if location information was being in the form of section identifiers. In 310, it is determined whether the location identifying information 116b provides information identifying a section or sections of the storage space. If so, in 320, the section identifier for the section or sections of the storage facility captured in the mobile device's image(s), is obtained from location information 116b. This information may be input into mobile device 110 by a user.

In 330, a search query using information regarding the relevant section or cell of the storage location is formed.

According to another embodiment, the selection of the appropriate portion of the image database information may be based on a combination of: (i) coordinate information obtained from mobile device's GPS sensors, (ii) directional vector information obtained from mobile device's compass component regarding a direction a camera of the mobile device is pointing to, and (iii) field of view (or camera aspect angle) information about the dimensions of a scene that a mobile devices camera is able to capture. In various embodiments, mobile device 110 provides such location, direction and field of view information 116b to the inventory assessment engine (together referred to as mobile-device-location information), at the time that it provides captured image information 116a.

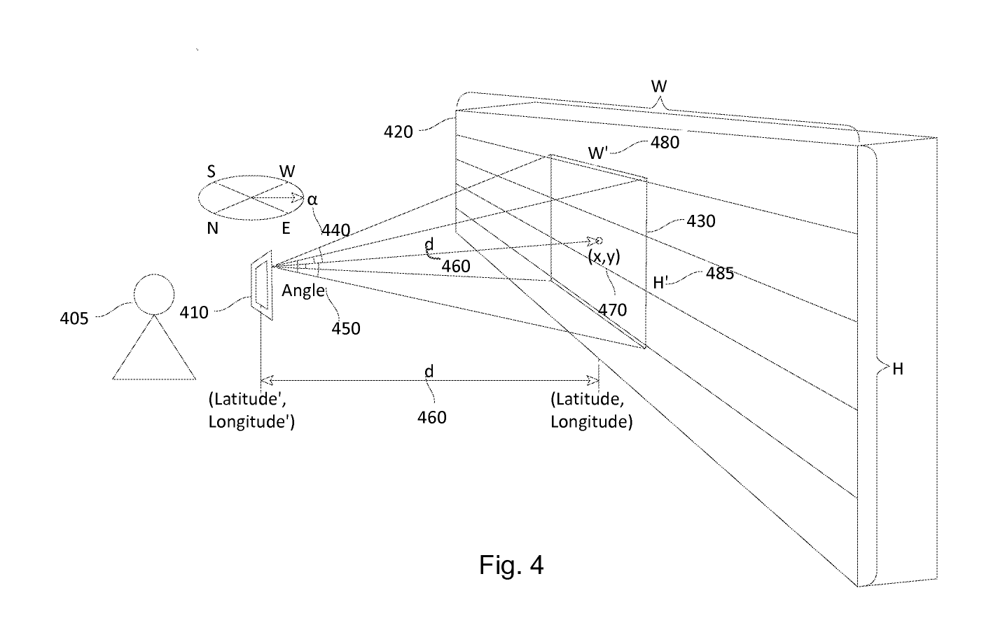

In such cases, a preprocessing of location information 116b may be necessary before a database query to image information database 133 can be formed. FIG. 4 provides a diagrammatic representation of such GPS location, compass directional vector, and field of view information as shown in the context of a user using a mobile device to take a picture of a portion of a warehouse shelf. FIG. 4 also identifies the variables that may be calculated in performing the above mentioned calculations.

FIG. 4 shows a user 405 taking a picture of warehouse shelves 420 using mobile device 410. The portion of the warehouse shelves captured in the picture is the shaded area 430. As noted above, using information obtained from mobile device 110's components and sensors, the dimensions and location of captured image area 430 can be calculated.

First, information from GPS component 112 of mobile device 110, combined with information regarding location of camera 111 within mobile device 110, may be used to obtain the x, y, z coordinates of mobile device 110's camera. This information combined with information stored in image information database 133 concerning the location of shelves within the storage facility may be used to determine distance “d” 460 between the camera and the location of the warehouse shelves captured in the image. The directional orientation vector 440 and the distance d 460 may be used to calculate the central point x, y 470 of the captured image. The directional orientation vector 440 is based on information obtained from a compass component of the mobile device, and shows a direction a camera of the mobile device is pointing to.

The central point x, y 470 of the captured image in combination with the distance d 460 and the aspect angle (also sometimes referred to as angle of view) 450 of the camera (i.e., the angle which determines the camera's field of view or visions) may be used to determine the dimensions width W′ 480 and height H′ 485 of the captured image. A camera's field of view determines the scope of the observable world that the camera can “see” in its viewfinder at a particular moment. If a camera has zoom capabilities, this angle of view can be adjusted depending on the zoom level chosen. The angle of view to be included in location information 116b is that which was used when the corresponding captured image was obtained.

One example of a process using such embodiments is described in the right branch of the flow diagram of FIG. 3.

In 340, with the GPS location information and stored map information showing where shelves are located, the distance d between the shelf and the camera is calculated. In 350, with the distance d and compass directional orientation information, the point (x, y) that maps to the central point of a field of view of the camera of the mobile device is calculated. In 360, with the distance d, the GPS location information and the camera angle of view information, dimensions of an image area (W′, H′) that is capturable by the camera is calculated. The dimensions (W, H′) reflect dimensions of the captured image. In 370, based on the point (x, y) and the dimensions (W′, H′), a query to the image information database information can be formed to obtain data regarding the section of the warehouse captured in the image.

In 380, the search query is transmitted to the image information database 133.

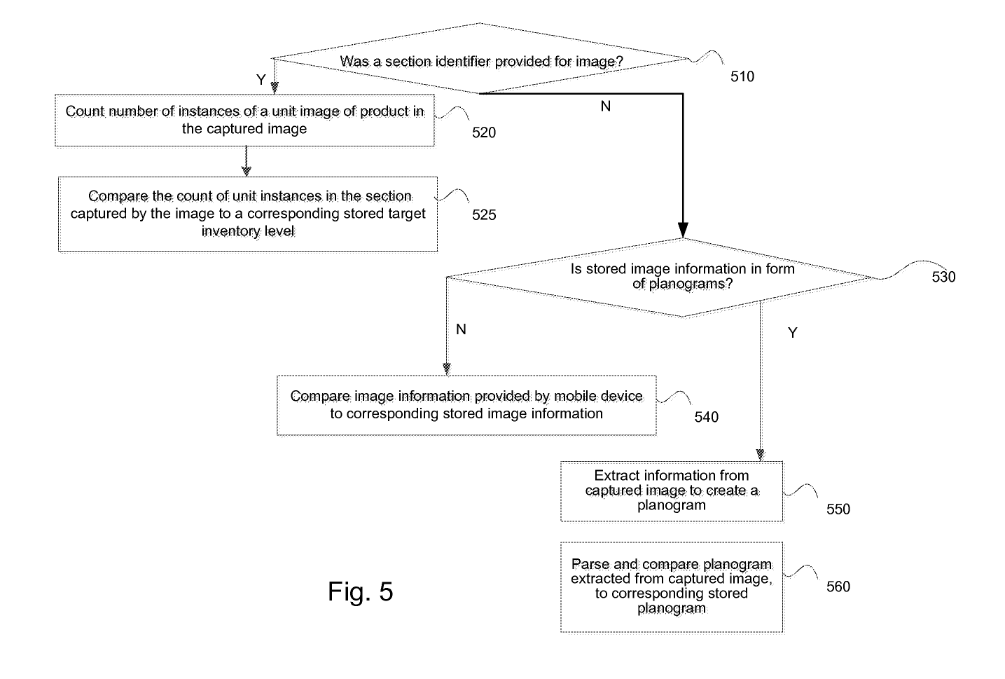

FIG. 5 shows a flow diagram which illustrates in more detail the comparison step 260 of FIG. 2. At 510, it is determined whether a section identifier for the imaged section was provided. The left branch of the diagram shows a process according to the structured space embodiment described above. As noted above, image information database 133 may contain an array of numbers, each number corresponding to a number of inventory items that should be contained in a particular section of the storage space. In 520, a number of units of inventory in the captured image 116a is determined by counting using object recognition processes the number of instances of unit image of the product in the captured image. In 520, this number is compared to the number retrieved from image information database 133 using the section identifier information provided in location information 116b by mobile device 110.

Steps 540, illustrate a process for comparison where the database stores target inventory level information as visual image files, such as .png files. In 540, image information 116a sent by mobile device 110 is compared to corresponding image data stored in the image information database regarding the same section of the physical location. The comparison may involve pixel-by-pixel comparison. The captured image may be compared with the image using whatever granularity is desired by a user, for example, pixel-by-pixel, or 1000 pixel-by-1000 pixel. The comparison may involve determining differences in the two images using differences in color, darkness, or other image features. Once a gap—that is, an area of with different image features—is identified, its dimensions may be determined, according to one embodiment. Then using image analysis techniques it may be determined how many units of the stored product, if any, may fit within that gap space, for example. If necessary, one or both of the images may be scaled so that the images are of comparable dimensions when performing the above comparison process.

Step 550 through 560 illustrates a process for comparison where the stored information regarding the storage facility takes the form of structured language files representing planograms, for example. Such structured languages, such as XML, may identify the characteristics of an image. Such representations are useful because they can be easily parsed/processed by a computing device to obtain key characteristics information, or to compare characteristics of one planogram to those of another planogram.

Planograms are primarily associated with retail stores, and optimizing presentation of inventory in a retail context to maximize sales. However, the information they collect may also be useful in the context of tracking inventory levels. For example, planograms usually identify at a minimum the products to be displayed, the positions of those products (e.g., x, y, z coordinates for the center of product) and orientations (in some cases, using three angles) of a surface—typically the front surface, and the quantities of those products to be placed in different locations, In some embodiments, planograms may also comprise a diagram of building fixtures and products showing the product in the pictorial context of its surroundings. Planograms may be created or saved in a variety of different formats. These may be text or box based. They may be pictorial. They may be diagrams or models. They may be represented in a computer language, for example, a structured language such as XML.

According to some embodiments, data regarding inventory-levels for different sections of a storage facility are stored in the form of planograms.

The example below uses .xml, but other structured languages, for example, such as .psa (Photoshop Album Catalog files) or .pln (files created using CAD design software which contain a three dimensional model) or other similar languages may also be used.

To illustrate, one example embodiment of use of planograms created using XML might involve breaking down an image of the storage facility into cells, and defining the width, height, and colors of each cell using the structured language, and then saving the structured language files. Color values do not have to be precise; they can be in a range required for compliance tolerance. Below is an example of XML code for a planogram describing a section of a storage facility:

```
<planogram>
  <row1 x=″0″, y=″0″, w=″100″, h=″20″>
    <column1 x=″0″, y=″0″, w=″20″, n_cell=3>
      <cell1 color_from=″#efefef″, color_to=″#989898″></cell1>
      <cell2 color_from=″#efefef″, color_to=″#989898″></cell2>
      <cell3 color_from=″#efefef″, color_to=″#989898″></cell3>
    </column1>
    <column2 x=″21″, y=″0″, w=″20″, n_cell=3>
      <cell1 color_from=″#efefef″, color_to=″#989898″></cell1>
      <cell2 color_from=″#efefef″, color_to=″#989898″></cell2>
      <cell3 color_from=″#efefef″, color_to=″#989898″></cell3>
    </column2>
    \check{S}\check{S}\check{S}
  <row2 x=″0″, y=″21″, w=″100″, h=″20″>
      \check{S}\check{S}\check{S}
  </row2>
  \check{S}\check{S}\check{S}
</planogram>
```

According to one embodiment, planograms reflecting an optimal state (including the optimal amounts of inventory) for a storage facility are stored in image information database 133. In the preprocessing and search stage 250, a stored planogram corresponding to the same section of the storage facility as the captured image(s) is retrieved from an image information database. Then in step 560, the information in such stored planogram is parsed and compared to the information in a planograms extracted or created from the captured images sent by the mobile device, such information extracted in step 550. By comparing information in the stored and newly created planograms, the difference between the presently existing, versus the desired, level of inventory may be determined.

The extracted planogram of the captured image may be compared with the corresponding portion of the stored planogram using whatever granularity is desired in a situation, for example, pixel-by-pixel, or 1000 pixel-by-1000 pixel.

FIGS. 6A-F provides examples of the contents of display 114 of mobile device 110 during different phases of the above described processes.

FIG. 6A shows a mobile device in the form of an iPhone upon which instructions to take a picture are displayed according to one embodiment of the present invention. In one embodiment, the user obtains one image of each portion of a storage facility. In other embodiments, a user may elect to obtain and submit to the inventory assessment engine multiple images of the same portion of the storage facility to provide more image data to the inventory assessment engine.

FIG. 6B illustrates an outline of a rectangular shape being overlaid over the camera's viewfinder image, in the display of the mobile device of FIG. 6A according to one embodiment of the present invention. The rectangular shape may be used as a guide to assist the user to capture more precisely one section of the storage facility in a captured image. Where section boundaries are denoted by dots or lines affixed to the shelves, in some embodiments, the user may align the rectangular outline to the section identifying markers to achieve even more precision.

FIG. 6C illustrates the mobile device of FIG. 6A upon which instructions to provide section identifying information regarding the section of the photographed storage space is displayed according to one embodiment of the present invention.

FIG. 6D illustrates the mobile device of FIG. 6A upon which instructions to take a picture of a single unit of the inventoried product is displayed according to one embodiment of the present invention. Note that the image of a single unit of the product obtained by the user should be a view of the product as seen when the product is stocked on a storage shelf, for example.

FIG. 6E illustrates the mobile device of FIG. 6A upon which instructions for the user to indicate if he/she would like to assess inventory in additional sections of the storage space is displayed according to one embodiment of the present invention. This option may be useful, for example, if a user wishes to assess inventory in each section of a storage facility, and then have the system compile all the obtained information to arrive at a count of total inventory.

FIG. 6F illustrates the mobile device of FIG. 6A upon which instructions for the user to indicate if he/she would like to place a purchase order to replenish inventory is displayed according to one embodiment of the present invention.

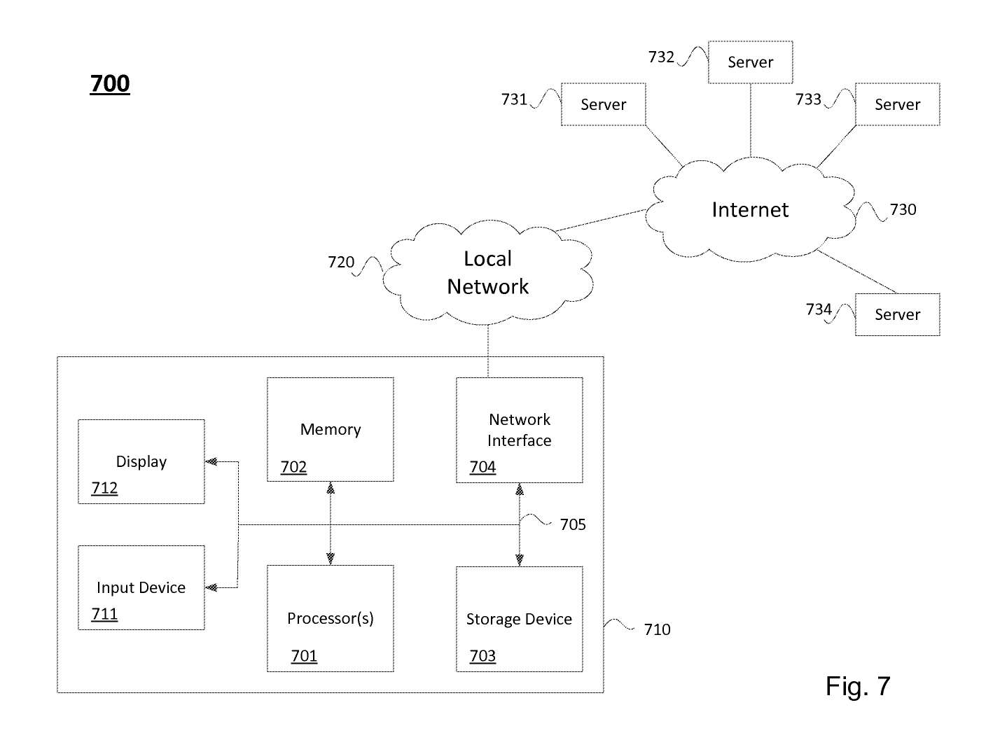

FIG. 7 illustrates hardware of a special purpose computing machine configured with a process according to the above disclosure. The following hardware description is merely one example. It is to be understood that a variety of computers topologies may be used to implement the above described techniques. An example computer system 710 is illustrated in FIG. 7. Computer system 710 includes a bus 705 or other communication mechanism for communicating information, and one or more processor(s) 701 coupled with bus 705 for processing information. One or more processor(s) 701 may take various forms including microcontrollers and microprocessors such as programmable devices (e.g., CPLDs and FPGAs) and unprogrammable devices such as gate array ASICs or general purpose microprocessors. Computer system 710 also includes a memory 702 coupled to bus 705 for storing information and instructions to be executed by processor 701, including information and instructions for performing some of the techniques described above, for example. This memory may also be used for storing programs executed by processor 701. Memory 702 may comprise a single or multiple storage components or devices. Possible implementations of this memory may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 703 may include source code, binary code, or software files for performing the techniques above, for example. Storage device and memory may both include any suitable non-transitory computer-readable media such as those described herein. Memory 702 and storage device 703 may comprise a single or multiple memory or storage components or devices, respectively.

Computer system 710 may be coupled via bus 705 to an output device 712 for providing information to a computer user. Output device 712 may take the form of a display or speakers, for example. An input device 711 such as a keyboard, touchscreen, mouse, and/or microphone, may be coupled to bus 705 for communicating information and command selections from the user to processor 701. The combination of these components allows the user to communicate with the system. In some systems, bus 705 may represent multiple specialized buses, for example.

Computer system 710 also includes a network interface 704 coupled with bus 705. Network interface 704 may provide two-way data communication between computer system 710 and a local network 720. The network interface 704 may be a wireless or wired connection, for example. Computer system 710 may send and receive information through the network interface 704 across a local area network, an Intranet, a cellular network, or the Internet, for example. One example implementation may include computing system 710 acting as an inventory assessment engine that receives image capture information from mobile devices, processes that information to determine inventory levels in the locations captured in the images, and provides that information to the mobile devices as described above. In the Internet example, computing system 710 may be accessed by the mobile devices through a wireless connection to the Internet, for example, and computing system 710 may access data and features on backend systems that may reside on multiple different hardware servers 731-735 across the network. Servers 731-735 and server applications may also reside in a cloud computing environment, for example. Various embodiments may be practiced in a wide variety of network environments including, for example, TCP/IP-based networks, telecommunications networks, cellular communications networks, wireless networks, etc., or combinations of different network types.

As noted above, the apparatuses, methods, and techniques described below may be implemented as a computer program (software) executing on one or more computers. The computer program may further be stored on a tangible non-transitory computer readable medium, such as a memory or disk, for example. A computer readable medium may include instructions for performing the processes described herein. Examples of such computer readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM).

In addition, the computer program instructions with which various embodiments of this disclosure are implemented may be executed according to a variety of computing models including a client/server model, a peer-to-peer model, on a stand-alone computing device, or according to a distributed computing model in which various functions described herein may be performed at different locations.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed:

1. A method comprising:
receiving, on a computing device, image data relating to an image captured by a mobile device, the captured image depicting one or more sections of an inventory location;
receiving location identifying data associated with the captured image;
processing the image data and location identifying data to determine a difference between a current inventory level and a full level of inventory of a product in the one or more sections of the physical location captured in the image;
generating meta data relating to the difference between the current inventory level and the full level of inventory; and
transmitting a representation of the meta data to the mobile device.

2. The method of claim 1 further comprising
generating, on a computing device, a representation of the captured image in which the captured image is overlaid with the meta data, wherein the overlaid representation of the meta data is transmitted to the mobile device.

3. The method of claim 1, wherein the inventory location is divided into sections to facilitate inventory assessment, and
wherein the location identifying data comprises section information corresponding to the section or sections of the inventory location depicted in the captured image, and wherein the section information is obtained via a user interface of the mobile device.

4. The method of claim 1, wherein the location identifying data comprises GPS location information relating to the location of the mobile device, compass information relating to the directional orientation of a camera of the mobile device, and camera angle of view information relating to a scope of the field of view capturable by the camera, and wherein such location identifying data is used to identify the section or sections of the inventory location captured by the captured image.

5. The method of claim 4, wherein said location identifying data is used to identify the section or sections of the inventory location captured by the captured image by a process comprising:
determining based at least in part on the GPS location information and stored map information showing a location of storage structures in the physical location, a distance d between a depicted storage structure and the camera of the mobile device;
determining based at least in part on the distance d and the compass information, a point (x, y) that maps to a central point of the field of view of the camera of the mobile device;
determining based at least in part on the distance d, the GPS location information and the camera angle of view information, dimensions of an image area (W′, H′) on the depicted storage structure, wherein the dimensions (W′, H′) reflect dimensions of the captured image;
determining based at least in part on the point (x, y) and the dimensions (W′, H′), dimensions and location of the section or sections of the inventory location captured by the image.

6. The method of claim 1, wherein determining a difference between a current inventory level and a full level of inventory in the one or more sections of the physical location, comprises:
retrieving, from an image information database, data regarding target inventory levels for the one or more sections of the physical location captured with the captured image,
wherein such target inventory level data is retrieved using the location identifying data received from the mobile device.

7. The method of claim 6, wherein the target inventory level data takes the form of an array, each element of the array comprising a number reflecting a target amount of the product to be stocked in a corresponding section of the inventory location.

8. The method of claim 6, wherein the target inventory level data takes the form of one or more planogram files, said planogram files representing design characteristics of all or part of the inventory location, including details relating to desired placement of inventory and desired quantity of inventory at different locations.

9. The method of claim 6, wherein a comparison process is performed on the captured image data and the target inventory level data corresponding to the section or sections of the inventory location captured in the captured image, such comparison process comprising:
retrieving an image of a single unit of such product, and determining, using image analysis and/or object recognition processes, a number of instances of the unit image contained in the captured image;
identifying a target inventory-level of inventory for the section or sections of the physical location associated with the captured image; and
comparing the number of instances of the unit image contained in the captured image with the identified target inventory-level data corresponding to the section or sections of the inventory location.

10. The method of claim 6, wherein a comparison process is performed on the captured image data and the target inventory level data corresponding to the section or sections of the inventory location captured in the captured image, such comparison process comprising:
extracting information from the image data to create a first planogram;
retrieving, from an image information database, a stored planogram, said planogram representing design characteristics of all or part of the inventory location, including details relating to desired placement of inventory and desired quantity of inventory at different locations, and
comparing the first planogram and the stored planogram.

11. The method of claim 1, wherein the meta data comprises information relating to a number of units of the product needed to fully replenish stock of the product.

12. The method of claim 1 wherein generating meta data comprises estimating when inventory is likely to be depleted based at least in part on sales forecasts for the product, and wherein the meta data comprises an estimated depletion date for the product.

13. A computer system comprising:
one or more processors; and
a non-transitory computer readable medium having stored thereon one or more programs, which when executed by the one or more processors, causes the one or more processor to singly or in combination:
receive image data relating to an image captured by a mobile device, the captured image depicting one or more sections of an inventory location;
receive location identifying data associated with the captured image;
process the image data and location identifying data to determine a difference between a current inventory level and a full level of inventory of a product in the one or more sections of the physical location captured in the image;
generate meta data relating to the difference between the current inventory level and the full level of inventory; and
transmit a representation of the meta data to the mobile device.

14. The computer system of claim 13 wherein the one or more processors:
generate a representation of the captured image in which the captured image is overlaid with the meta data, wherein the overlaid representation of the meta data is transmitted to the mobile device.

15. The computer system of claim 13, wherein the location identifying data comprises GPS location information relating to the location of the mobile device, compass information relating to the directional orientation of a camera of the mobile device, and camera angle of view information relating to the scope of a field of view capturable by the camera, and wherein such location identifying data is used to identify the section or sections of the inventory location captured by the captured image.

16. The computer system of claim 15, wherein said location identifying data is used to identify the section or sections of the inventory location captured by the captured image by a process comprising:
determining, based in part on the GPS location information and stored map information showing a location of storage structures in the physical location, a distance d between a depicted storage structure and the camera of the mobile device;
determining, based at least in part on the distance d and the compass information, a point (x, y) that maps to a central point of the field of view of the camera of the mobile device;
determining, based at least in part on the distance d, the GPS location information and the camera angle of view information, dimensions of an image area (W′, H′) on the depicted storage structure, wherein the dimensions (W′, H′) reflect dimensions of the captured image;
determining, based at least in part on the point (x, y) and the dimensions (W′, H′), dimensions and location of the section or sections of the inventory location captured by the image.

17. The computer system of claim 13, wherein determining a difference between a current inventory level and a full level of inventory in the one or more sections of the physical location captured in the image, comprises
retrieving, from an image information database, data regarding target inventory levels for the one or more sections of the physical location captured with the captured image,
wherein such target inventory level data is retrieved using the location identifying data received from the mobile device.

18. The computer system of claim 17, wherein a comparison process is performed on the captured image data and the retrieved target inventory level data, such comparison process comprising:
extracting information from the image data to create a first planogram;
retrieving, from an image information database, a stored planogram, said planogram representing design characteristics of all or part of the inventory location, including details relating to desired placement of inventory and desired quantity of inventory at different locations, and
comparing the first planogram and the stored planogram.

19. The computer system of claim 17, wherein a comparison process is performed on the captured image data and the retrieved target inventory level data, such comparison process comprising:
retrieving an image of a single unit of such product, and determining, using image analysis and/or object recognition processes, a number of instances of the unit image contained in the captured image;
identifying a target inventory-level for the section or sections of the physical location associated with the captured image; and
comparing the number of instances of the unit image contained in the captured image with the identified target inventory-level.

20. A non-transitory computer readable storage medium storing one or more programs, the one or more programs comprising instructions for:
receiving image data relating to an image captured by a mobile device, the captured image depicting one or more sections of an inventory location;
receiving location identifying data associated with the captured image;
processing the image data and location identifying data to determine a difference between a current inventory level and a full level of inventory of a product in the one or more sections of the physical location captured in the image;
generating meta data relating to the difference between the current inventory level and the full level of inventory; and
transmitting a representation of the meta data to the mobile device.
